(19) United States
(12) Patent Application Publication
(10) Pub. No.: US 2021/0339357 A1
(43) Pub. Date: Nov. 4, 2021

(54) MICROCHANNEL ELECTROPHORESIS-ASSISTED MICRO-ULTRASONIC MACHINING APPARATUS AND METHOD BASED ON THREE DIMENSIONAL PRINTING MOLD

(71) Applicant: Lingnan Normal University, Zhanjiang (CN)

(72) Inventors: Haishan LIAN, Zhanjiang (CN); Manfeng GONG, Zhanjiang (CN); Deyun MO, Zhanjiang (CN); Shuzhen JIANG, Zhanjiang (CN); Xiaojun CHEN, Zhanjiang (CN); Xingzao MA, Zhanjiang (CN)

(73) Assignee: Lingnan Normal University, Zhanjiang (CN)

(21) Appl. No.: 16/921,939

(22) Filed: Jul. 7, 2020

(30) Foreign Application Priority Data
Apr. 30, 2020 (CN) 202010365323.6

(51) Int. Cl. B24B 31/06; B03C 5/02; B29C 64/188; B33Y 40/20; B24B 49/02; B24B 31/00

(52) U.S. Cl. CPC B24B 31/06; B03C 5/02; B24B 31/003; B33Y 40/20; B24B 49/02; B29C 64/188

(57) ABSTRACT

A microchannel electrophoresis-assisted micro-ultrasonic machining apparatus based on a 3D printing mold includes a working platform, a power supply, a 3D printing mold, a working solution tank and an ultrasonic vibration system. The working platform is configured to secure the apparatus. The working solution tank is provided with electrophoresis-assisted electrodes. The ultrasonic vibration system is secured to the lower end of the transfer module. The positive electrode of the electrophoretic DC power supply is electrically connected to the tool and the negative electrode is electrically connected to the electrophoresis-assisted electrodes. A workpiece to be processed is assembled with a 3D printing mold. After assembly, the workpiece and the 3D printing mold are placed in the middle of the electrophoresis-assisted electrodes inside the working solution tank and arranged to correspond to the tool.

### CROSS REFERENCE TO THE RELATED APPLICATIONS

This application is based upon and claims priority to Chinese Patent Application No. 202010365323.6, filed on Apr. 30, 2020, the entire contents of which are incorporated herein by reference.

### TECHNICAL FIELD

The present invention relates to the technical field of micro special machining, and more specifically, to a microchannel electrophoresis-assisted micro-ultrasonic machining apparatus and method based on a three-dimensional (3D) printing mold.

### BACKGROUND

Microchannels are an important part of micro-reactors and micro-fluidic systems. Integrated microchannel systems are widely used in chemical, optical, biomedical and military fields. Materials like glass, ceramics, and silicon are high-performance materials for preparing microchannels due to advantages thereof such as stable chemical performance, high reliability, high-pressure resistance and high-temperature resistance, which is conducive to driving electro-osmotic flow.

However, hard brittle materials such as glass and silicon with high brittleness makes micro-processing difficult. The high cost of producing microfluidics components using the special technique limits the large scale use of hard brittle materials such as glass and silicon in the field of machining microchannels.

Currently, with the rapid expansion of the microchannel processing technology, the glass micro-processing technology mainly includes: chemical etching, mechanical processing, ultrasonic processing, glass thermoforming, laser processing, etc.

1) The chemical etching method for microchannels is a commonly used processing method. The shaped microchannel is obtained by a mask in hydrogen fluoride (HF) corrosive environment, and the needed pattern of the mask is obtained by surface processing, photoresist coating, optical exposure and development. The chemical etching method is cumbersome, costly and is not environmentally friendly.

2) The mechanical processing method for glass microchannels requires a specific tool grinder, and the glass stresses need to be controlled when processing, which is relatively difficult in processing.

3) The glass thermoforming method includes compression molding, blow molding, and roll molding, which utilizes the continuous rapid increase of the viscosity of the glass with temperature decreasing to gradually harden the fluid glass into solid glass. The microfluidics requires large areas of fine channel construction, which makes the process more complex and costly.

4) The laser machining method for microchannels focuses high-energy laser beams on the surface of the material processing zone to create a high-temperature melt or gasification, thereby forming a processing shape. The method is simple, and the patterns are directly formed without masking, which is environmentally friendly and efficient.

5) The conventional ultrasonic processing method requires the prefabricated specific-shaped tools matching with microchannels. The small size of microchannels will cause more difficulty in the making of the ultrasonic processing tool. Moreover, the micro-scale tool is extremely easy to be wear-out and the utilization rate of abrasive materials is low.

Currently, lasers are widely regarded as one of the most effective methods for micro-and-nano machining, but normal infrared-band lasers are difficult to be focused on glass surfaces due to the high transparency of glass materials. The processing costs are higher when the blue-purple bands or ultra-fast laser is used to process the micro structures.

Therefore, it is desirable for a low-cost, environmentally-friendly and high-quality processing apparatus and method.

### SUMMARY

The present invention provides a microchannel electrophoresis-assisted micro-ultrasonic machining apparatus and method based on a 3D printing mold that improves processing quality, reduces cost and protects the environment.

The microchannel electrophoresis-assisted micro-ultrasonic machining apparatus based on the 3D printing mold includes a work platform, a power supply, the 3D printing mold, a working solution tank and an ultrasonic vibration system. The working platform includes a marble platform and a two-dimensional (2D) motion platform. The marble platform is used to fix an electrophoresis-assisted micro-ultrasonic machining apparatus. The 2D motion platform is located at one end of the upper plane of the marble platform; and the other end of the upper plane of the marble platform is provided with a marble pillar. One end of the marble pillar is fixed to the marble platform and the other end is provided with a vertical slide platform. An end of the vertical slide platform away from the end of the marble pillar is provided with a transfer module, and the transfer module is configured to connect and install each component.

The ultrasonic vibration system is fixed to the lower end of the transfer module. The working solution tank and the ultrasonic vibration system are correspondingly arranged at the upper end of the 2D motion platform. The upper end of the transfer module is provided with a power transmission mechanism. The working solution tank is provided with electrophoresis-assisted electrodes. The ultrasonic vibration system includes an ultrasonic transducer, a nodal plane, an ultrasonic horn and a tool. The ultrasonic transducer is fixed to the lower end of the transfer module by the nodal plane. The ultrasonic horn and the tool are arranged successively at the lower end of the ultrasonic transducer. The power supply includes an ultrasonic power supply and an electrophoretic DC (direct current) power supply. The ultrasonic power supply is electrically connected to the power transmission mechanism, and the power transmission mechanism is configured to transfer electrical energy between the ultrasonic transducer and the ultrasonic power supply. The positive electrode of the electrophoretic DC power supply is electrically connected to the tool via the power transmission mechanism and the negative electrode is electrically connected to the electrophoresis-assisted electrodes. A workpiece to be processed is assembled with the 3D printing mold, and then, after assembly, the workpiece and the 3D printing mold are placed at the middle of the electrophoresis-assisted electrodes inside the working solution tank and arranged to correspond to the tool.

Further, the working solution tank contains an ultra-fine abrasive particle mixed working solution formed by ultra-fine abrasive particles and a working solution.

Further, the vibration amplitude of the tool is 10 to 100 μm.

Further, the bottom end of the said tool is immersed in the ultra-fine abrasive particle mixed working solution inside the working solution tank.

Further, the electrophoresis-assisted electrodes are installed inside the working solution tank, and the electrophoresis-assisted electrodes are partially or entirely immersed in the ultra-fine abrasive particle mixed working solution inside the working solution tank.

A microchannel electrophoresis-assisted micro-ultrasonic machining method based on 3D printing mold includes the following steps:

S10, establishing a corresponding 3D drawing of the microchannel mold by 3D modeling software according to a pattern of the microchannel required by the workpiece to be processed.

S20, importing the 3D drawing of the microchannel mold into slicing software and slicing the 3D drawing to obtaining a slicing file, wherein the 3D drawing of the microchannel mold imported into the slicing software is in a STL format;

S30, importing the slicing file to a 3D printer and enabling the 3D printer to print a physical mold.

S40, assembling the workpiece to be processed with the mold and then installing on the electrophoresis-assisted micro ultrasonic machining apparatus for electrophoresis-assisted micro ultrasonic machining;

S50, taking out the finished workpiece from the mold to obtain the final processed product.

Further, the 3D drawing of the microchannel mold imported into the slicing software is in the STL format.

Further, the slicing file is in a G-CODE format.

Advantages of the present invention:

1. In the machining apparatus and machining method disclosed by the present invention, the physical mold of microchannel of complex structures can be produced by 3D molding, slicing and printing. The shape of the mold is copied to the workpiece by the electrophoresis-assisted micro-fine ultrasonic machining apparatus, which achieves the processing of complex structures of the microchannel.

2. The present invention collects the ultra-fine abrasive particles in the solution to the machining area through the electrophoresis effect of the ultra-fine abrasive particle, effectively improving the utilization of the ultra-fine abrasive particle and saving the machining cost.

3. The cost and time spent on producing the microchannel by the machining method of the present invention are not related to the complex structures of the microchannel. The apparatus of producing the microchannel has a relatively simple structure and the production cost is low.

4. In the machining apparatus of the present invention, the control system and the tool of the electrophoresis-assisted micro-fine ultrasonic machining apparatus does not need to be specific to the complexity of the microchannel. The mold printed by the 3D printer can greatly reduce the requirements of the control system and tool of the apparatus.

### BRIEF DESCRIPTION OF THE DRAWINGS

FIG. 1 is a schematic diagram showing the structure of the microchannel electrophoresis-assisted micro-ultrasonic machining apparatus based on 3D printing mold; and

FIG. 2 is a schematic diagram showing the installation of the 3D printing mold and the workpiece.

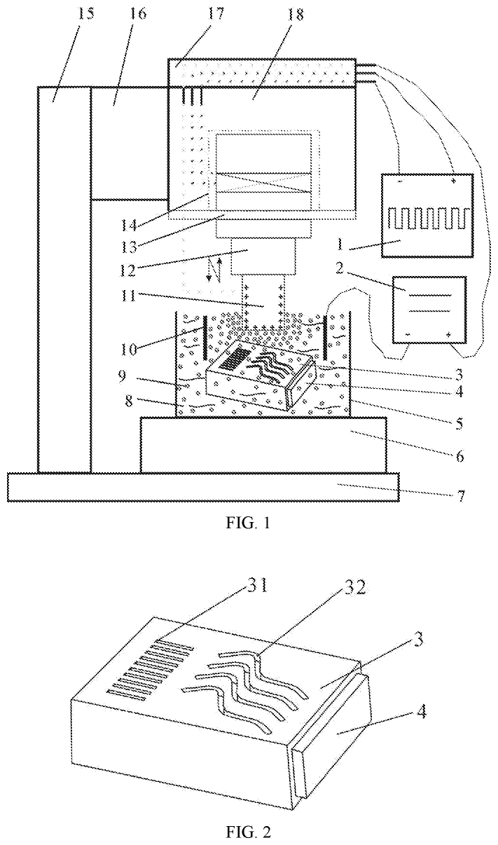

In the figures, 1, ultrasonic power supply, 2, electrophoretic DC power supply, 3, 3D printing mold, 31, linear channel, 32, curved channel, 4, workpiece to be processed, 5, working solution tank, 6, 2D motion platform, 7, marble platform, 8, working solution, 9, ultra-fine abrasive particle; 10, electrophoresis-assisted electrode; 11, tool; 12, ultrasonic horn; 13, nodal plane; 14, ultrasonic transducer; 15, marble pillar; 16, vertical slide platform; 17, power transmission mechanism; 18, transfer module.

### DETAILED DESCRIPTION OF THE EMBODIMENTS

### Embodiment 1

The microchannel electrophoresis-assisted micro-ultrasonic machining apparatus based on 3D printing mold 3 includes the work platform, the power supply, the 3D printing mold 3, the working solution tank 5, the ultrasonic vibration system.

The working platform includes the marble platform 7 and the 2D motion platform 6. The marble platform 7 is used to fix the electrophoresis-assisted micro-ultrasonic machining apparatus. The 2D motion platform 6 is arranged at one end of the upper plane of the marble platform 7, and the other end of the upper plane of the marble platform 7 is provided with the marble pillar 15.

One end of the marble pillar 15 is fixed to the marble platform 7 and the other end is provided with a vertical slide platform 16. The end of the vertical slide platform 16 away from the end of the marble pillar 15 is provided with the transfer module 18, and the transfer module 18 is configured to connect and install each component.

The ultrasonic vibration system is fixed to the lower end of the transfer module 18. The working solution tank 5 and the ultrasonic vibration system are correspondingly arranged at the upper end of the 2D motion platform 6. The upper end of the transfer module 18 is provided with the power transmission mechanism 17. The working solution tank 5 is provided with the electrophoresis-assisted electrodes 10.

The ultrasonic vibration system includes the ultrasonic transducer 14, the nodal plane 13, the ultrasonic horn 12 and the tool 11. The ultrasonic transducer 14 is fixed inside the lower end of the transfer module 18. The nodal plane 13, the ultrasonic horn 12 and the tool 11 are arranged successively at the lower end of the ultrasonic transducer 14. The ultrasonic vibration system is fixed to the transfer module 18 by the nodal plane 13. In this way, the ultrasonic vibration system can move up and down in the direction of the z-axis, thereby controlling the distance between the plane of the tool 11 and the workpiece 4 to be processed.

The power supply includes the ultrasonic power supply 1 and the electrophoretic DC power supply 2. The ultrasonic power supply 1 is electrically connected to the power transmission mechanism 17, and the power transmission mechanism 17 is configured to transfer electrical energy between the ultrasonic transducer 14 and the ultrasonic power supply 1. The positive electrode of the electrophoretic DC power supply 2 is electrically connected to the tool 11 via the power transmission mechanism 17 and the negative electrode is electrically connected to the electrophoresis-assisted electrodes 10. The workpiece 4 to be processed is assembled with the 3D printing mold 3, and then, after assembly, the workpiece 4 and the 3D printing mold 3 are placed at the middle of electrophoresis-assisted electrodes 10 inside the working solution tank 5 and are arranged to correspond to the tool 11.

In the embodiment, the working solution tank 5 contains the ultra-fine abrasive particle mixed working solution formed by the ultra-fine abrasive particles 9 and the working solution 8.

In the embodiment, the vibration amplitude of the tool 11 in the ultrasonic vibration system is 10-100 μm. Furthermore, the bottom end of the tool 11 is immersed in the ultra-fine abrasive particle mixed working solution inside the working solution tank 5.

The electrophoresis-assisted electrodes 10 are installed inside the working solution tank 5. The electrophoresis-assisted electrodes 10 are partially or entirely immersed in the ultra-fine abrasive particle mixed working solution inside the working solution tank, and preferably, entirely immersed in the ultra-fine abrasive particle mixed working solution. The electrical field is formed between the tool 11 and the electrophoresis-assisted electrodes.

The working principle of the embodiment is as follows. The ultra-fine abrasive particles in the ultra-fine abrasive particle mixture working solution absorb the negative charges in the solution due to the large surface, so that the ultra-fine abrasive particles present electrical features. The ultra-fine abrasive particles in the solution are influenced by the electric field and move to the machining area, and then are absorbed or semi-adsorbed onto the tool 11, so that the concentration of the abrasive particles in the machining area increases, which efficiently utilizes the abrasive particles.

The high-frequency vibration of the tool 11 drives the high-frequency vibration of the ultra-fine abrasive particles in the machining area. The materials, which are uncovered by the 3D printing mold on the machining area of the workpiece 4 to be processed, are removed by the impact of the high-frequency vibration abrasive particles. Since the rest of the materials on the machining area are covered by the 3D printing mold 3, the plastic material of the 3D printing mold is directly impacted by the abrasive particles. As a result, the rest of the materials, such as straight channel 31 and the curved channel 32, cannot be removed.

The 2D motion platform 6 is controlled to move, so that the areas to be processed on the workpiece 4 to be processed are covered evenly by the end surface of the tool 11, without the need for precise motion tracking control. The microchannel is processed and the processing time is determined by the depth and shallow of the microchannel process.

The microchannel electrophoresis-assisted micro-ultrasonic machining method based on the 3D printing mold includes the following steps.

S10, the corresponding 3D drawing of the microchannel mold is established by 3D modeling software, according to the pattern of the microchannel required by the workpiece to be processed.

S20, the 3D drawing of the microchannel mold is imported into the slicing software and the 3D drawing is sliced to obtain the slicing file, wherein, the 3D drawing of the microchannel mold imported into the slicing software is in the STL format;

S30, the slicing file is imported into the 3D printer, and enabling the 3D printer to print the physical mold. The format of slicing file is the G-CODE format.

S40, the workpiece to be processed is assembled with the mold and then the workpiece and the mold are installed on the electrophoresis-assisted micro ultrasonic machining apparatus for electrophoresis-assisted micro ultrasonic machining;

S50, the finished workpiece is removed from the mold to obtain the final processed product.

The above description only shows the better embodiments of the present invention rather than restricting the technical scope of the present invention. Therefore, any modifications and equivalent changes to the above embodiment in accordance with the technical essence of the present invention shall fall into the scope of the technical solution of the present invention.

What is claimed is:

1. A microchannel electrophoresis-assisted micro-ultrasonic machining apparatus based on a 3D printing mold, comprising: a working platform, a power supply, a 3D printing mold, a working solution tank, an ultrasonic vibration system, wherein,
the working platform comprises a marble platform and a 2D motion platform, wherein, the marble platform is configured to secure an electrophoresis-assisted micro-ultrasonic machining apparatus, the 2D motion platform is located at a first end of an upper plane of the marble platform, and a second end of the upper plane of the marble platform is provided with a marble pillar;
a first end of the marble pillar is secured to the marble platform, a second end of the marble pillar is provided with a vertical slide platform, an end of the vertical slide platform is away from the marble pillar and is provided with a transfer module, the transfer module is configured to connect and install each component, and the ultrasonic vibration system is secured to a lower end of the transfer module;
the working solution tank and the ultrasonic vibration system are arranged at an upper end of the 2D motion platform, an upper end of the transfer module is provided with a power transmission mechanism, and the working solution tank is provided with electrophoresis-assisted electrodes;
the ultrasonic vibration system comprises an ultrasonic transducer, a nodal plane, an ultrasonic horn and a tool, wherein, the ultrasonic transducer is secured to the lower end of the transfer module by the nodal plane, the ultrasonic horn and the tool are arranged successively at a lower end of the ultrasonic transducer;
the power supply comprises an ultrasonic power supply and an electrophoretic DC power supply, the ultrasonic power supply is electrically connected to a power transmission mechanism, the power transmission mechanism is configured to transfer electrical energy between the ultrasonic transducer and the ultrasonic power supply, a positive electrode of the electrophoretic DC power supply is electrically connected to the tool via the power transmission mechanism, and a negative electrode of the electrophoretic DC power supply is electrically connected to the electrophoresis-assisted electrodes; and
a workpiece to be processed is assembled with the 3D printing mold; after assembly, both of the workpiece and the 3D printing mold are placed in a middle of the electrophoresis-assisted electrodes inside the working solution tank and are arranged to correspond to the tool.

2. The microchannel electrophoresis-assisted micro-ultrasonic machining apparatus based on the 3D printing mold according to claim 1, wherein the working solution tank contains the ultra-fine abrasive particle mixed working solution formed by ultra-fine abrasive particles and a working solution.

3. The microchannel electrophoresis-assisted micro-ultrasonic machining apparatus based on the 3D printing mold according to claim 2, wherein a vibration amplitude of the tool is 10 to 100 μm.

4. The microchannel electrophoresis-assisted micro-ultrasonic machining apparatus based on the 3D printing mold according to claim 3, wherein a bottom end of the tool is immersed in the ultra-fine abrasive particle mixed working solution inside the working solution tank.

5. The microchannel electrophoresis-assisted micro-ultrasonic machining apparatus based on the 3D printing mold according to claim 4, wherein the electrophoresis-assisted electrodes are installed inside the working solution tank, and the electrophoresis-assisted electrodes are partially or entirely immersed in the ultra-fine abrasive particle mixed working solution inside the working solution tank.

6. A microchannel electrophoresis-assisted micro-ultrasonic machining method based on a 3D printing mold, comprising the following steps:
S10, establishing a 3D drawing of a microchannel mold by 3D modeling software according to a microchannel structure, wherein the microchannel structure corresponds to a workpiece to be processed;
S20, importing the 3D drawing of the microchannel mold into slicing software, and slicing the 3D drawing to obtain a slicing file;
S30, importing the slicing file to a 3D printer, and enabling the 3D printer to print a physical mold;
S40, assembling the workpiece to be processed with the physical mold and installing the workpiece to be processed and the physical mold on an electrophoresis-assisted micro ultrasonic machining apparatus for electrophoresis-assisted micro ultrasonic machining;
S50, taking out a finished workpiece from the physical mold to obtain a final processed product;

7. The microchannel electrophoresis-assisted micro-ultrasonic machining method based on the 3D printing mold according to claim 6, wherein the 3D drawing of the microchannel mold imported into the slicing software is in a STL format.

8. The microchannel electrophoresis-assisted micro-ultrasonic machining method based on the 3D printing mold according to claim 7, wherein the slicing file is in a G-CODE format.
